(19) United States
(12) Patent Application Publication
(10) Pub. No.: US 2006/0006817 A1
(43) Pub. Date: Jan. 12, 2006

(54) AC powered self organizing wireless node

(76) Inventors: Marc K. Chason, Schaumburg, IL (US); Janice M. Danvir, Arlington Heights, IL (US); Katherine M. Devanie, Glendale Heights, IL (US); David A. Hume, Deer Park, IL (US); Tomasz L. Klosowiak, Glenview, IL (US); Kevin J. McDunn, Lake In The Hills, IL (US)

Correspondence Address: MOTOROLA, INC., 1303 EAST ALGONQUIN ROAD, IL01/3RD, SCHAUMBURG, IL, 60196, US

(21) Appl. No.: 11/126,686

(22) Filed: May 11, 2005

Related U.S. Application Data
(60) Provisional application No. 60/570,877, filed on May 13, 2004.

(51) Int. Cl. G05F 1/00; H05B 37/02

(52) U.S. Cl. 315/291

(57) ABSTRACT

An alternating current (AC) powered self organizing wireless node (100, 400, 600) includes a self organizing wireless receiver-transmitter (115), an AC branch connection (105), an AC to direct current (DC) converter (110), a secondary power function (120), and a housing (150). The self organizing wireless receiver-transmitter can communicate information throughout a network of compatible self organizing nodes solely using radio transmission to and reception from nearby self-organizing nodes. The secondary power function can couple power to the AC to DC converter for powering the self organizing wireless receiver-transmitter when AC power is not provided. The AC powered self organizing wireless node is designed and fabricated for agency certification. The AC powered self organizing wireless node may include one or more sensors (125), sensor inputs (135), transducers (130), or control outputs (155).

### FIELD OF THE INVENTION

The field of this invention is self organizing networks, and more specifically, the design of nodes used for in-building self organizing networks.

### BACKGROUND

There are at least two technologies being developed that relate to self organizing networks: Bluetooth® scatternet technology and Zigbee™ type network technology. One hope is that these technologies can simplify the implementation of a control and sensing network by using many low cost, low power radio sensing and control nodes within a region wherein the nodes are densely placed such that radio communication to all nodes can be accomplished by passing information among the nodes, thereby avoiding a need for radio communication to each node directly from a central system controller. This reduces the radio frequency emissions to very low levels that don't interfere with other radio uses in spite of the pervasive nature of the network.

Since a self organizing sensor and control network would be beneficial, particularly in commercial buildings, for such things as fire sensing, chemical sensing, temperature sensing, and lighting control, it would be advantageous to reduce the costs of installing and maintaining nodes of such a system.

### BRIEF DESCRIPTION OF THE DRAWINGS

The present invention is illustrated by way of example and not limitation in the accompanying figures, in which like references indicate similar elements, and in which:

FIG. 1 is a block diagram of an AC powered self organizing wireless node, in accordance with some embodiments of the present invention;

FIGS. 2 and 3 are perspective drawings of the AC powered self organizing wireless node, in accordance with some embodiments of the present invention;

FIGS. 4 and 5 are a cross sectional view and a perspective view of an AC powered self organizing wireless node that includes a solid state illumination source, in accordance with some embodiments of the present invention;

FIG. 6 is a perspective drawing of an AC powered self organizing wireless node, in accordance with some embodiments of the present invention; and

FIG. 7 is a network diagram of a portion of an exemplary network that comprises a plurality of compatible self organizing wireless nodes, in accordance with some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE DRAWINGS

Before describing in detail the particular wireless node in accordance with the present invention, it should be observed that the present invention resides primarily in combinations of method steps and apparatus components related to wireless networks. Accordingly, the apparatus components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

One possible application for low power, low cost sensor and control nodes is systems maintenance and control within buildings. Systems that are used in many commercial buildings include lighting systems and fire detection systems. Better use of control and new technology in building lighting systems offers a potential for large energy savings. For most existing buildings, the lighting system includes light fixtures that operate from alternating current (AC) branch circuits. For example, in the USA, branch circuits provide a nominal 120 VAC for powering the most common AC power fixtures (light fixtures, fan fixtures, emergency services fixtures, etc.), In numbers, virtually all of the light fixtures use either incandescent or fluorescent bulbs operating in light fixtures designed for incandescent or fluorescent lamps. (Some fluorescent lamps operate in incandescent light fixtures.) There are billions of such light fixtures in existence. Although fluorescent lamps are substantially more efficient than incandescent lamps, they are still highly inefficient when evaluated in terms of the amount of electrical power used versus the light power generated. Solid state lamps have the potential to drastically increase the efficiency of lighting, but are presently much more expensive to purchase. Someday solid state lamps may predominate as new and replacement lamps, perhaps first in commercial establishments in which the labor costs of installing amps are substantial.

Commercial buildings, as noted above, typically also have fire detectors installed in or above ceilings.

The receiver-transmitters used in the AC powered self organizing wireless network nodes of the present invention are designed to be powered from a low voltage direct current source. Some versions of these receiver transmitters are capable of operating for up to a couple of years from a very small battery, so are made into self organizing wireless nodes by being permanently connected to a low power, long life battery. In such form they are considered to be disposable when or before the battery dies. The present invention uniquely provides embodiments of AC powered self organizing wireless nodes that can be installed in a building as a part of an AC fixture (e.g., a light fixture or a fan fixture, or an emergency services fixture) without adding any labor costs for installing the self organizing wireless nodes. The AC powered self organizing wireless nodes include power failure backup capability and may include sensors, sensor inputs, transducers, or control outputs. The present invention also permits the installation of controllable lighting that can be accomplished in existing lighting systems without additional labor costs. These benefits are achieved using AC powered self organizing wireless network nodes that can be maintenance free for several years to many years (i.e., decades).

Referring to FIG. 1 a block diagram is shown of an AC powered self organizing wireless node 100, in accordance with some embodiments of the present invention. The AC powered self organizing wireless node (SOWN) 100 comprises a self organizing wireless receiver-transmitter 115, an alternating current (AC) branch connection 105, an AC to direct current (DC) converter and power control 110, a secondary power function 120, and a housing 150. “AC powered” in the context of this document means powered by power from AC branch circuits, such as those that provide electrical power at 100 to 250 Volts and 50 or 60 Hz worldwide. For connection to such AC branch circuits, design and manufacturing certification must be obtained from a government approved agency. Such certification demonstrates compliance of a product to safety and mechanical configuration standards (e.g., screw terminal types, wire sizes, prong dimension, insulation materials, distances between branch circuit voltage conductors, grounding, etc.). An element of a product or a whole product that meets such compliance standards are described hereinafter as being “agency approved” for simplicity of description.

The self organizing wireless receiver-transmitter (SOWRT) 115 can communicate information throughout a network of compatible self organizing nodes solely using radio transmission to and reception from nearby self-organizing nodes that likewise communicate to nearby nodes. The SOWRT 115 preferably meets a wireless air interface standard for self organizing network receiver-transmitters. Examples of such wireless air interface standards are those commonly known as Bluetooth®D and Zigbee™. (At this time, some Bluetooth® standards are released, whereas Zigbee™ standards are generally in development). The AC to DC converter and power control 110 is coupled to the AC branch connection 105 and converts AC power to DC power that is used to operate the self organizing Wireless receiver-transmitter 115, among other functions of the AC powered self organizing wireless node 100. The secondary power function 120 is coupled to the AC to DC converter and power control 110 and can couple DC power to the AC to DC converter and power control 110 for powering the self organizing wireless receiver-transmitter when AC power is not provided at the AC branch connection 105.

The DC power may be provided by a capacitor or battery that is also attached to the housing, or the battery may be connected to and retained to the housing by a suitable battery connector or holder. A capacitor or long life battery (e.g., a lithium battery) or rechargeable battery may be suitable for providing sufficient backup power to power at least the receiver transmitter for a duration judged long enough to reduce the risk of having no communication to the receiver-transmitter to a desired low level. When a capacitor or long life battery is used, it may be soldered into and considered a part of the secondary power function 120. There might be some situations in which a replaceable battery or a rechargeable battery is appropriate as a DC power source for the secondary power function. In this case, a battery connector attached to the housing 150 and a battery connected by the battery connector may be considered a part of the secondary power function 150. The secondary power function 120 and AC-DC converter and power control function 110 may control the supply of power during AC power outages to provide power to a subset of the SOWN 100, as described in more detail below.

The housing 150 mechanically unitizes the self organizing wireless receiver-transmitter 115, the AC to DC converter 110, and the secondary power function 120. The SOWN 100 is designed and fabricated to achieve agency certification, such as Underwriter Labs certification to National Electric Code requirements in the USA, or European Certification to comparable European electrical code requirements. The SOWRT 115 may include, in addition to radio frequency receiving and transmitting circuits, one or more application specific integrated circuits and one or more microprocessors 115 with associated programmed instructions and memory to perform the functions described herein. A network of SOWNs 100 and other compatible self organizing wireless nodes (e.g, DC powered nodes that use the same air interface standard) can be installed in a building and can be then used to provide sensor signals (such as temperature, smoke, carbon monoxide, radon, humidity) to a system controller (not shown) and to provide control signal outputs that control such devices as lamps, fans, and valves by means of relays or, in some embodiments, directly.

In some embodiments, a control output 155 is generated by the SOWRT 115, by which is meant that the control output 155 is provided at the outside of the housing 150 in response to a command received by the SOWRT 115. The control output 155 may be electrically modified to achieve appropriate electrical drive levels and self protection, by circuitry coupled between an output of the SOWRT 115 and the control output 155. The control output 155 termination may be in the physical form of wires, terminal screws, solder tabs, or other well known connectors. The control output 155 is affixed to the housing 150 and is controlled by the SOWRT 115 in response to a command received in information that is communicated to the SOWRT 1115 via a network of compatible self organizing wireless nodes, typically from a system controller of the network of compatible self organizing wireless nodes. In some instances the SOWRT may transmit or relay the information without the information being used within the SOWN that is transmitting or relaying the information. A plurality of independent control outputs may also be provided. In some embodiments, a controlled transducer 130, such as an audible alert device is provided.

In some embodiments, a sensor 125 is included in the SOWRT 115. The sensor 125 is affixed to the housing and coupled to the SOWRT 115, which communicates the state of the sensor 125 via a self organizing wireless network to a system controller. The sensor can be, for example, a temperature sensor, a humidity sensor, a carbon monoxide sensor, or an acoustic sensor.

In some embodiments, a plurality of sensors 125 are included in the SOWRT 115. In some embodiments, one or more sensor inputs 135 are provided (only one is shown) that are coupled to the SOWT 115, by which is meant that sensor inputs 135 are provided at the outside of the housing ISO, and a signal coupled to the sensor input 135 from an external device may be modified for appropriate electrical drive levels and self protection by circuitry between the sensor input 135 and the SOWRT 115. The sensor input 135 may be in the physical form of wires, terminal screws, solder tabs, or other well known connectors. In some instances the sensor input may be transmitted by the SOWRT to other nodes for control of a remote device.

The secondary power function 120 and the AC-DC power control 1110 may operate to supply power only to a subset of the SOWN 100 when there is an AC power outage. For example, power may be supplied only to the receiver-transmitter 115, or to the receiver-transmitter 115 and a critical sensor or transducer such as a temperature sensor or alert transducer.

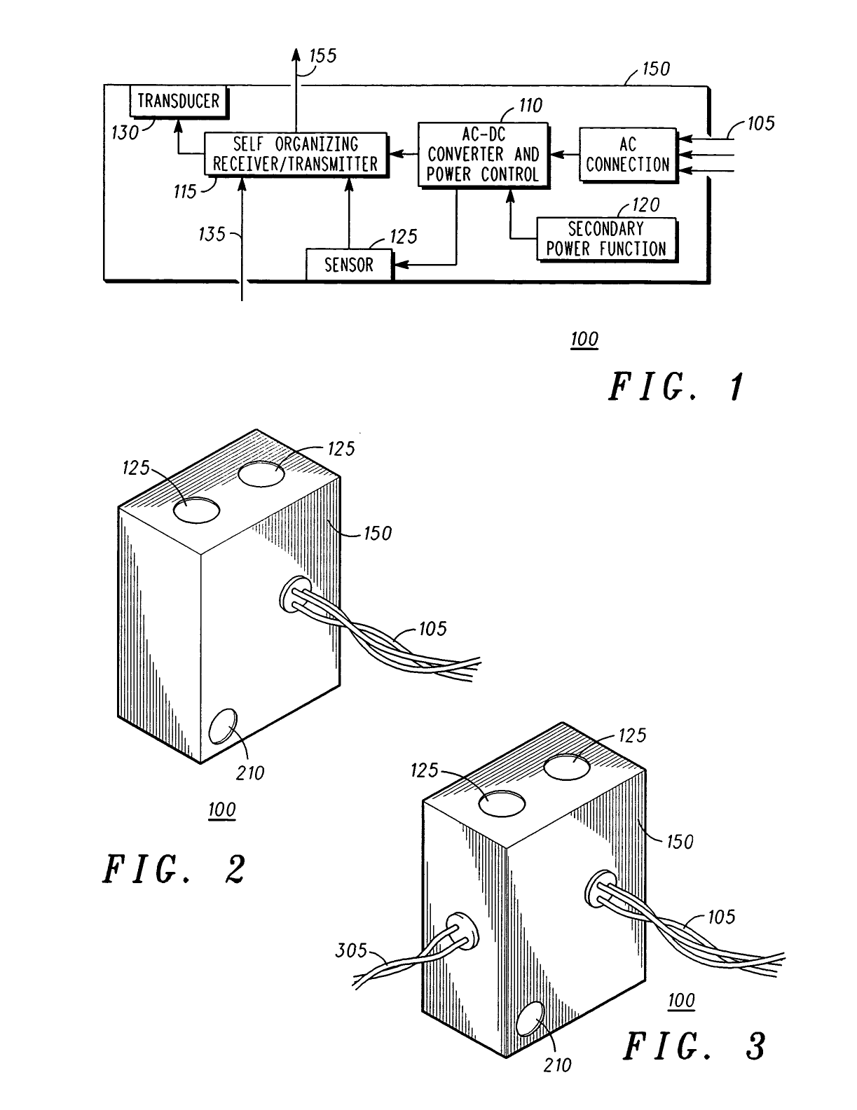

Referring to FIGS. 2 and 3, a perspective drawing of the SOWN 100 is shown, in accordance with some embodiments of the present invention. In this embodiment, the SOWN 100 is designed and fabricated to achieve agency certification as a device for use within an agency certified AC housing. In these embodiments, the AC branch power connection may comprise three wire pigtails 105 as illustrated, or other approved AC wiring terminations, such as screws or wires with spade lugs attached. The SOWN 100 of these embodiments may conveniently be installed in such agency approved housings as an electrical box (for example, a wall box of the type used for switches or outlets or wall mount light fixtures), or in the portion of an electrical fixture having the effective equivalent of an electrical box, such as the electrical box of a fluorescent light fixture that houses a ballast, or the electrical box of a “top hat” ceiling light fixture, or inside the AC wiring region of any electrical fixture that plugs into a wall outlet, such as a desk lamp, a free standing light fixture, free standing heater, or a free standing fan, just to name a few fixtures that may be common in some commercial buildings. The housing and other electrical requirements for such installations are well known and may allow the housing 150 to be, for example, sheet metal that does not completely enclose the SOWN 100, or molded plastic. The embodiment of the SOWN 100 shown in FIG. 2 has a threaded screw bushing 210 molded into a molded housing 150 for mounting the SOWN 100 in a fixture, but other known echniques could be used (holes in sheet metal when the housing 150 is sheet metal, etc.) It can be appreciated that the use of these embodiments of the SOWN 100 can provide ceiling light fixtures, such as fluorescent light fixtures that are installed in panels of dropped ceilings or hung in factories, or top hat light fixtures that are installed in panels of dropped ceilings, that have the SOWN 100 wired in; thus providing the installation of the SOWN 100 at no extra labor cost. The SOWRT 115 can control a conventional light in the fixture when the light fixture is designed to be controllable (such as by a relay to which the control output 155 is connected). For these types of uses, an external antenna may be needed to conduct the RF energy out of an essentially complete metallic enclosure that surrounds the SOWN 100. These uses of the SOWN 100 can therefore simultaneously provide lighting that may be controlled via the self organized network and a network of sensors for other functions. Similarly, the SOWRT 115 of the SOWN 100 may control other AC powered devices such as fans or heaters when the SOWN 100 is installed in fixtures with such AC powered devices that are controllable. FIG. 3 illustrates a version of SOWN 100 that includes wire pigtails 305 that may be either a sensor input 135 (FIG. 1) or a control output 155 (FIG. 1). The SOWN 100 may be incorporated into furniture such as benches, or partition brackets that have AC power distribution channels in them.

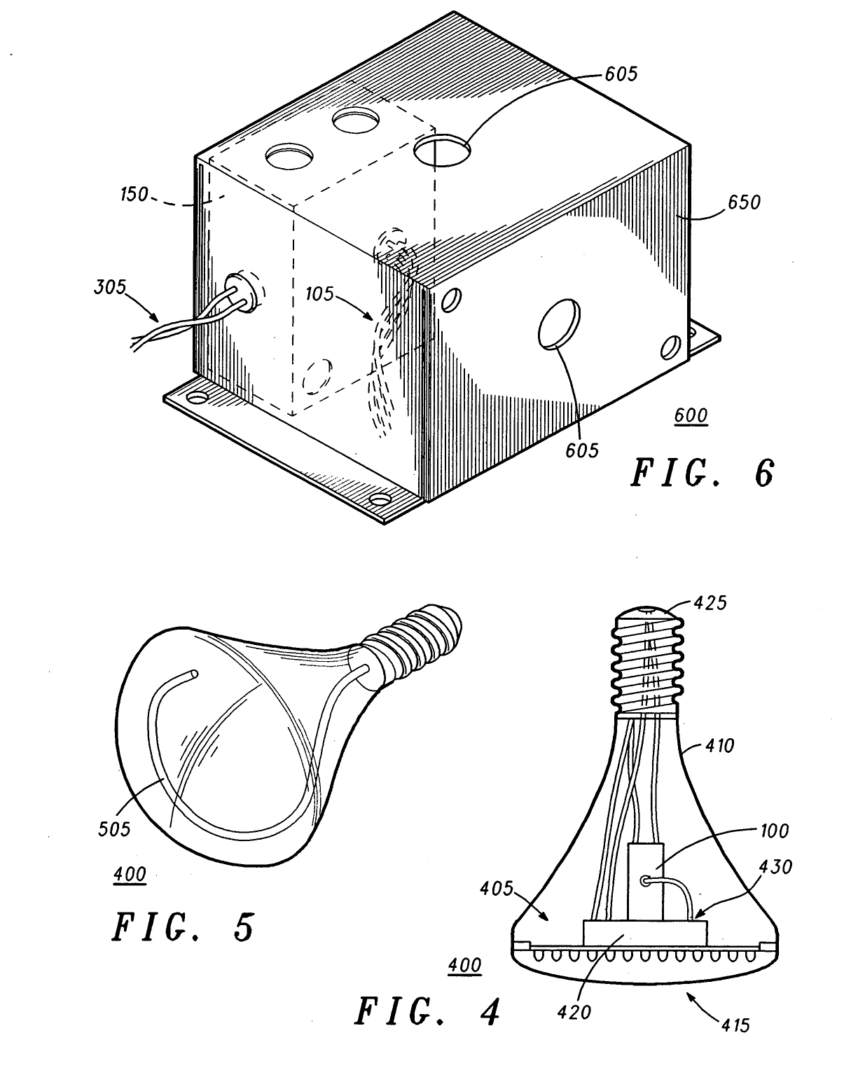

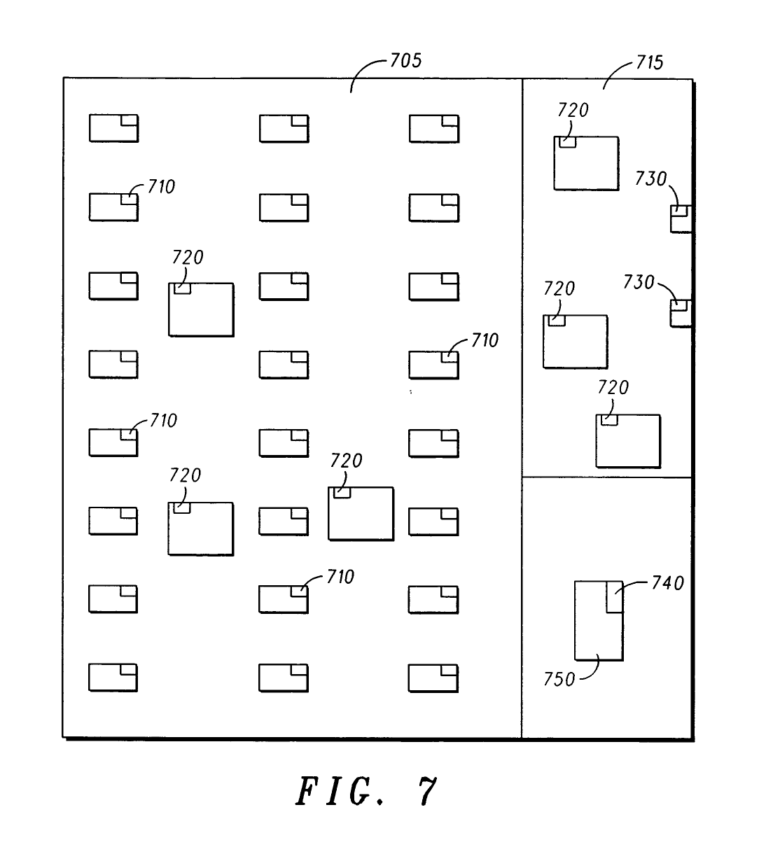

Referring to FIGS. 4 and 5, a cross sectional view (FIG. 4) and a perspective view (FIG. 5) of a SOWN 400 that includes a solid state illumination source 405 are shown in accordance with some embodiments of the present invention. The SOWN 400 essentially comprises an SOWN 100 as described above and the solid state illumination source 405, which are housed within a bulb housing 410 that is the shape and size of a standard light bulb. The bulb housing 410 is preferably transparent plastic or polymeric material. The solid state illumination source 405 may be a module that comprises a plurality of Light Emitting Diodes (LEDS) 415 and an electronic module 420 to convert AC to DC and drive the plurality of LEDS 415. The plurality of LEDS 425 may be all white, or some other color or mix of colors. The electronic module 420 and the SOWN 100 are connected to an agency approved standard AC screw base 425 to obtain AC power. The electronic module 425 converts AC to DC to power the white LEDS 415 and has a control input 430 that is connected to the control output 150 of the SOWN 100. The illumination source 405 may be controlled by a system controller of a self organizing wireless network within which the SOWN 400 operates, in response to signals conveyed to the system controller by other controllers, or in response to time schedules set within the system controller, or in response to information from sensors within the self organizing wireless network. In some embodiments, the illumination source may be not under the control of the SOWN 100, and in other embodiments, the illumination source 405 may not be included in the bulb shaped housing 410. In some embodiments, the bulb shaped housing 410 may be molded to perform the function of the SOWN 100 housing 150. Referring to FIG. 5, a conductive metal pattern 505 is inside the bulb housing 410 but extends away from the LEDS 415 around a periphery of the bulb housing 410. The conductive metal pattern 505 forms an external wide beam antenna for a SOWN 400 that may be installed in a recessed manner in a light fixture, such as a top hat fixture, such that without the antenna, the radiation pattern may be to directional. Other antenna placements may be adequate for a particular air interface standard and average fixture separations within a self organizing wireless network for example the antenna may be a part of the SOWN 150.

In some embodiments, the housing 410 may not be in the shape of a standard light bulb, but rather may be designed simply to fit within the space of a standard light bulb. In some embodiments, the AC to DC conversion functions of the SOWN 100 and the solid state illumination source 405 may be performed by one circuit instead of two. In related embodiments, the SOWN 400 could be in the form of a fluorescent light bulb having agency approved standard fluorescent end caps.

It will be appreciated that a SOWN 400 has the advantage of being able to be installed in existing light fixtures with very low labor cost, and when the SOWN 400 incorporates a solid state illumination source 405, the installation of the SOWN 400 as a replacement for conventional lamps provides for substantial energy cost savings and simultaneously can provide a network of sensors for other functions.

Referring to FIG. 6, a perspective drawing of an AC powered self organizing wireless node (SOWN) 600 is shown, in accordance with some embodiments of the present invention. In these embodiments, the SOWN 600 comprises an exterior housing 650 that is an agency approved AC electrical housing, to which AC power may be coupled in an approved manner. This housing has one or more entry portals 605 that allow for mechanical attachment of an AC cable or conduit and protected space for connecting AC wires, as is appropriate to meet electrical codes in regions where the SOWN 600 will be used. Although an interior housing 150 of the SOWN 600 is also shown, the housing 650 may also perform the function of housing 150 as well. The SOWN 600 may be installed anywhere in a building where no other AC powered devices are to be installed, and where long term use (i.e, several to many years) without maintenance is desired. The SOWN 600 may be incorporated into a functional or decorative panel such as an acoustic ceiling tile.

Referring to FIG. 7, a network diagram is shown of a portion of an exemplary network 700 that comprises a plurality of compatible self organizing wireless nodes, in accordance with some embodiments of the present invention. The portion of the network 700 comprises a network portion 705 that includes a plurality (24 are shown) of SOWNs 710 that are located within fluorescent fixtures. The SOWNs 710 may be of the same type as SOWNs 100. The network portion 705 is representative of a network portion formed on one floor of a building that is a factory floor. The portion of the network 700 may be a portion of a compatible network that includes other floors of the building (not shown in FIG. 2). The portion of the network 700 further comprises self organizing wireless nodes 720, 730 in a warehouse part of the building floor that includes the factory floor. Self organizing wireless nodes 720 are located on factory pallets and are not connected to the AC branch circuits of the building. Self organizing wireless nodes 720 are not AC powered self organizing wireless nodes, but are nodes that are locally powered (by battery or solar cell, for example), that communicate using the same air interface as the AC powered self organizing wireless nodes. The SOWNs 730 are AC powered and are located in the warehouse section 715 at fixed locations such that self organizing wireless nodes 720 on any pallets within the warehouse will be within the network 700. Thus, the network 700 is a network of (air interface) compatible nodes even though some are not AC powered. At least one self organizing wireless node 740 of the network 700 is coupled to a network controller 750. The network controller 750 receives information from self organizing wireless nodes 710, 720, 730 that may include sensor statuses, and transmits information to self organizing wireless nodes 710, 720, 730 that may include commands to change the state of control outputs. The information is passed to or received from a particular node in the manner prescribed in the interface standard, conveyed from node to nearby node to reach a destination. The controller 750 is a computer that may have a display and keyboard as peripherals, and has application programs to utilize the state information of the sensors 125 and generate information to command states of the control outputs 150. Unlike some prior art controlled solid state light bulbs, lights that are controllable within a network of AC powered self organizing nodes of the present invention may be controlled in a manner completely independent of sensor information that is being acquired by sensors within the self organizing network 700. There may be more than one system controller 750 operating within the self organizing network 700. Sensor information from the self organizing wireless nodes 710, 720, 730 may be communicated to a controller that is not operating as a wireless node in the self organizing network 700. A controller that is not operating as a wireless node in the self organizing network 700 may communicate control information to the self organizing wireless nodes 710, 720, 730. There may be wireless nodes of the network 700 that are capable of accepting and using or generating information that is more complex than sensor information, such as text information. The controller 750 is one example of such a wireless node, but a device such as a text display coupled to an SOWN 100, 600 having a control output 150 that conveys serial data is another example. Such text information is conveyed to and from a text capable node by the self organizing wireless nodes 710, 720, 730 in the same manner as sensor and control information. The communication of such text information may not be practical or possible in some embodiments of self organizing wireless networks 700.

It will be appreciated that system controller 750 and self organizing receiver-transmitter 115 described herein may comprise one or more conventional processors and unique stored program instructions that control the one or more processors to implement some, most, or all of the functions described herein; as such, these functions may be interpreted as steps of a method. Alternatively, these functions could be implemented by a state machine that has no stored program instructions, in which state machine each function or some combinations of certain of the functions are implemented as custom logic. Of course, a combination of the two approaches could be used. Thus, methods and means for these functions have been described herein.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

The term “another”, as used herein, is defined as at least a second or more. The terms “including” and/or “having”, as used herein, are defined as comprising. The term “coupled”, as used herein with reference to electro-optical technology, is defined as connected, although not necessarily directly, and not necessarily mechanically. The term “program”, as used herein, is defined as a sequence of instructions designed for execution on a computer system. A “program”, or “computer program”, may include a subroutine, a function, a procedure, an object method, an object implementation, an executable application, an applet, a servlet, a source code, an object code, a shared library/dynamic load library and/or other sequence of instructions designed for execution on a computer system. It is further understood that the use of relational terms, if any, such as first and second, top and bottom, and the like are used solely to distinguish one entity or action from another entity or action without necessarily requiring or implying any actual such relationship or order between such entities or actions.

What is claimed is:

1. An alternating current (AC) powered self organizing wireless node, comprising:
a self organizing wireless receiver-transmitter that can communicate information throughout a network of compatible self organizing nodes solely using radio transmission to and reception from nearby self-organizing nodes;
an alternating current (AC) branch connection;
an AC to direct current (DC) converter coupled to the AC branch connection that converts AC power to DC power to operate the self organizing wireless receiver-transmitter;
a secondary power function that is coupled to the AC to DC converter, that can couple power to the AC to DC converter for powering the self organizing wireless receiver-transmitter when AC power is not provided at the AC branch connection; and
a housing that mechanically unitizes the self organizing wireless receiver-transmitter, the AC to DC converter, and the secondary power function, wherein the AC powered self organizing wireless node is designed and fabricated for agency certification.

2. The AC powered self organizing wireless node according to claim 1, further comprising at least one control output that is affixed to the housing and controlled by the self organizing wireless receiver-transmitter in response to information that is communicated to the self organizing wireless receiver-transmitter via the network of compatible self organizing wireless nodes.

3. The AC powered self organizing wireless node according to claim 1, further comprising at least one sensor that is affixed to the housing and coupled to the self organizing wireless receiver-transmitter that communicates a state of the sensor via the self organizing wireless network to a system controller.

4. The AC powered self organizing wireless node according to claim 1, wherein the AC powered self organizing wireless node is designed and fabricated for agency certification as a device for use within an agency certified AC housing, and wherein the AC branch connection comprises AC wiring terminations.

5. The AC powered self organizing wireless node according to claim 4, wherein the agency certified AC housing is one of a standard electrical box and a portion of an electrical fixture.

6. The AC powered self organizing wireless node according to claim 1, wherein the AC powered self organizing wireless node is designed and fabricated for agency certification for use in a lamp fixture, and wherein the AC branch connection is an agency certified AC lamp connector.

7. The AC powered self organizing wireless node according to claim 6, further comprising an antenna that is external to the housing.

8. The AC powered self organizing wireless node according to claim 6, wherein the agency certified AC lamp connector is one of a screw base, a bayonet base, and a pair of fluorescent caps.

9. The AC powered self organizing wireless node according to claim 6, wherein the AC powered self organizing wireless node is within a housing having a shape and size of a standard light bulb.

10. The AC powered self organizing wireless node according to claim 6, further comprising one or more solid state light sources coupled to the AC to DC converter.

11. The AC powered self organizing wireless node according to claim 10, further comprising a control output that can control light output of the one or more solid state light sources, wherein the control output is controlled by the self organizing wireless receiver-transmitter in response to information that is communicated to the receiver-transmitter via the network of compatible self organizing wireless nodes

12. The AC powered self organizing wireless node according to claim 1, further comprising an exterior housing that is an agency certified AC electrical housing, to which an AC power cable may be terminated in an approved manner.

13. The AC powered self organizing wireless node according to claim 12, wherein the agency certified AC electrical housing comprises brackets for attachment to building structural elements.

14. The AC powered self organizing wireless node according to claim 13, wherein the building structural elements consist of one of metal framing members, wooden framing members, and dropped ceiling rails.

15. The AC powered self organizing wireless node according to claim 1, further comprising one of a functional building panel and a decorative building panel in which the AC powered self organizing wireless node is incorporated.

16. The AC powered self organizing wireless node according to claim 15, for which the one of a functional building panel and a decorative building panel forms the housing.

17. The AC powered self organizing wireless node according to claim 1, wherein the self organizing receiver-transmitter meets a wireless air interface standard for self organizing network receiver-transmitters.

18. The AC powered self organizing wireless node according to claim 1, wherein the secondary power function comprises at least one of a capacitor, a battery, a replaceable battery, a rechargeable battery and a battery connector.

19. A self organized wireless network, comprising:
a plurality of AC powered self organizing wireless nodes, each comprising
a self organizing wireless receiver-transmitter that can communicate information throughout a network of compatible self organizing nodes solely using radio transmission to and reception from nearby self-organizing nodes,
an alternating current (AC) branch connection,
an AC to direct current (DC) converter coupled to the AC branch connection that provides converts AC power to DC power to operate the self organizing wireless receiver-transmitter,
a secondary power function that is coupled to the AC to DC converter, that can couple power to the AC to DC converter for powering the self organizing wireless receiver-transmitter when AC power is not provided to the AC branch connection, and
a housing that mechanically unitizes the self organizing wireless receiver-transmitter, the AC to DC converter, and the secondary power function, wherein the AC powered self organizing wireless node is designed and fabricated for agency certification; and
a system controller that can receive information via the network of compatible self organizing nodes from any node and transmit information via the network of compatible self organizing nodes to any node.

20. The self organized wireless network according to claim 19, further comprising an AC powered self organizing wireless node that comprises a control output that is controlled by the self organizing Wireless receiver-transmitter of the AC powered self organizing wireless node in response to information that is communicated to the receiver-transmitter via the network of compatible self organizing wireless nodes from the system controller.

21. The self organized network according to claim 20, wherein the control output is controlled in response to information other that that generated by a sensor that is coupled to a receiver-transmitter of an AC powered self organizing wireless node of the network of compatible self organizing wireless nodes.

22. The self organized wireless network according to claim 19, further comprising an AC powered self organizing wireless node that comprises a sensor that is coupled to the self organizing Wireless receiver-transmitter of the AC powered self organizing wireless node to provide sensor state information that is communicated from the receiver-transmitter via the network of compatible self organizing wireless nodes to the system controller.
